(19) United States
(12) Patent Application Publication
(10) Pub. No.: US 2005/0106914 A1
(43) Pub. Date: May 19, 2005

(54) High frequency electronic ballast lamp interconnects

(75) Inventors: Earl F. Crandall, Raleigh, NC (US); Robert C. Smallwood SR., Englewood, CO (US); Byunghwan Chay, Simpsonville, SC (US)

Correspondence Address: BURNS DOANE SWECKER & MATHIS L L P, POST OFFICE BOX 1404, ALEXANDRIA, VA, 22313-1404, US

(73) Assignee: Transworld Lighting, Inc.

(21) Appl. No.: 10/817,072

(22) Filed: Apr. 2, 2004

Related U.S. Application Data
(60) Provisional application No. 60/460,506, filed on Apr. 4, 2003.

(51) Int. Cl. H01R 33/02

(52) U.S. Cl. 439/226

(57) ABSTRACT

A cabinet light system includes integral male and female connectors to allow the interconnection of multiple units directly or with an interconnection cord. The cabinet light system includes a lamp connection system with a florescent strip lamp, a male interconnector, a female interconnector, an enclosure channel, and a ballast. The male and female interconnectors are connected to opposite ends of the enclosure channel and are electrically connected to the ballast to provide power to the ballast.

### RELATED APPLICATIONS

This application claims priority under 37 C.F.R. § 119 to provisional application Ser. No. 60/460,506 filed on Apr. 4, 2003, entitled “High Frequency Electronic Ballast Lamp Interconnects,” which is incorporated by reference herein in its entirety.

### BACKGROUND

The present invention relates generally to connectors for gas discharge lamps.

Fluorescent light operates by creating a discharge or arc across an ionized gas within a glass tube. In traditional fluorescent lighting, the gas tube is filled with mercury vapor which, when ionized, can collide with electrons of a current flow across the electrodes of a lamp, and emit photons. These photons strike fluorescent material on the inner wall of the glass tube and produce visible light.

Fluorescent lamps require a ballast to operate. The ballast conditions the electric power to produce the input characteristics needed for the lamp. When arcing, the lamp exhibits a negative resistance characteristic, and therefore needs some control to avoid a cascading discharge. Both manufacturers and the American National Standards Institute specify lamp characteristics, which include current, voltage, and starting conditions. Historically, 50-60 Hz ballasts relied on a heavy core of magnetic material; today, most modem ballasts are electronic.

Electronic ballasts can include a starting circuit and may or may not require heating of the lamp electrodes for starting or igniting the lamp. Prior to ignition, a lamp acts as an open circuit; when an arc is created the lamp starts, the entire ballast starting voltage is applied to the lamp. After ignition, the current through the lamp increases until the lamp voltage reaches equilibrium based on the ballast circuit. Ballasts can also have additional circuitry designed to filter electromagnetic interference (EMI), correct power factor errors for alternating current power sources, filter noise, etc.

Electronic ballasts typically use a rectifier and an oscillating circuit to create a pulsed flow of electricity to the lamp. Common electronic lighting ballasts convert 60 Hz line or input current into a direct current, and then back to a square wave alternating current to operate lamps near frequencies of 20-40 kHz. Some lighting ballasts further convert the square wave to more of a sine wave, typically through an LC resonant lamp network to smooth out the pulses to create sinusoidal waveforms for the lamp. See, for example, U.S. Pat. No. 3,681,654 to Quinn, or U.S. Pat. No. 5,615,093 to Nalbant.

The square wave approach is common for a number of reasons. Many discrete or saturated switches are better suited to the production of a square wave than a sinusoidal wave. In lower frequency applications, a square wave provides more consistent lighting; a normal sinusoid at low frequency risks de-ionization of the gas as the voltage cycles below the discharge level. A square wave provides a number of other features, such as constant instantaneous lamp power, and favorable crest factors. With a square wave, current density in the lamp is generally stable, promoting long lamp life; similarly, there is little temperature fluctuation, which avoids flicker and discharge, damaging the lamp.

It is known that higher frequencies can produce more efficient lighting. In general, if de-ionization is minimized or avoided, then less energy is needed because there is no re-ionization of the gas; that is, a higher frequency avoids the cycle of decay and recovery of ionization within the lamp. Further, the anode fall voltage can be lower when the frequency is higher than the oscillation frequency of the plasma.

However, higher frequency ballasts suffer some problems. First, electronic ballasts can create harmonic disturbance, due in part to the use of pulses or square wave signals. Harmonics are signals in which the frequency is a whole number multiple of the system's fundamental frequency; the third harmonic is most damaging. The total harmonic distortion (or “THD”) is one measure of ballast performance. Harmonics create unexpected or nonlinear loading of circuit elements; the harmonic signals cause voltage drops at points of impedance, at the frequency of the harmonic current. At high frequency, the circuitry required to convert a square wave into a sinusoidal wave may limit the available frequency of operation; high frequency voltage drops can change the voltage values of the fundamental wave. A ballast with a high THD may also create electromagnetic interference with nearby electrical equipment, necessitating additional circuitry to filter harmonics; however, such circuits can introduce additional problems such as high inrush current. Second, as discussed in U.S. Pat. No. 5,173,643 to Takehara, it is generally believed that operating frequencies above 50 KHz may introduce stray capacitance into lamp circuitry. Finally, the semiconductor switches of many oscillating circuits in electronic ballasts have faced inefficiency or losses, including thermal dissipation, at high frequency driving. Thus, ballast technology has heretofore been limited, thereby also limiting the opportunity for improved energy efficiency.

### SUMMARY

In one aspect, a cabinet light system includes integral male and female connectors to allow the interconnection of multiple units directly or with an interconnection cord. The cabinet light system includes a lamp connection system with a florescent strip lamp, a male interconnector, a female interconnector, an enclosure channel, and a ballast. The male and female interconnectors are connected to opposite ends of the enclosure channel and are electrically connected to the ballast to provide power to the ballast.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a frontal plan view of a 9 Watt Fluorescent Cabinet Light.

FIGS. 2A-2C are several views of an enclosure channel and enclosure channel cover.

FIG. 3 is a frontal plan view of the ballast completely assembled with attached internal wiring and lamp holders/interconnecting connectors according to an aspect of the invention.

FIG. 4 is a schematic of a ballast according to an aspect of the invention.

FIG. 5 is a frontal plan view of a lamp holder/interconnecting connector for “power-in” according to an aspect of the invention.

FIG. 6 is side view of a lamp holder/interconnecting connector for “power-in” according to an aspect of the invention.

FIG. 7 is side view of a lamp holder/interconnecting connector for “power-out” according to an aspect of the invention.

FIG. 8 is view of a detachable power supply cord according to an aspect of the invention.

FIG. 9 is frontal plan and connector views of an interconnection cord according to an aspect of the invention.

### DETAILED DESCRIPTION

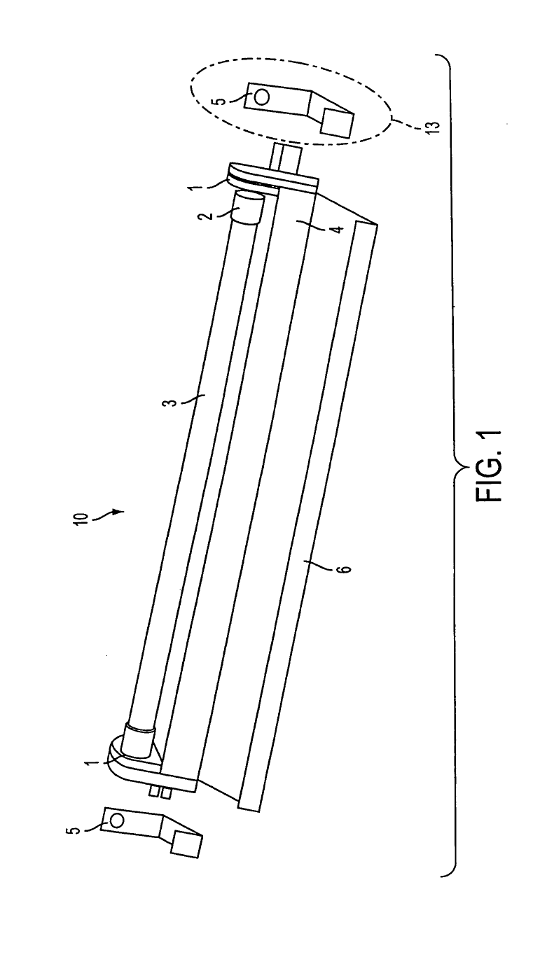

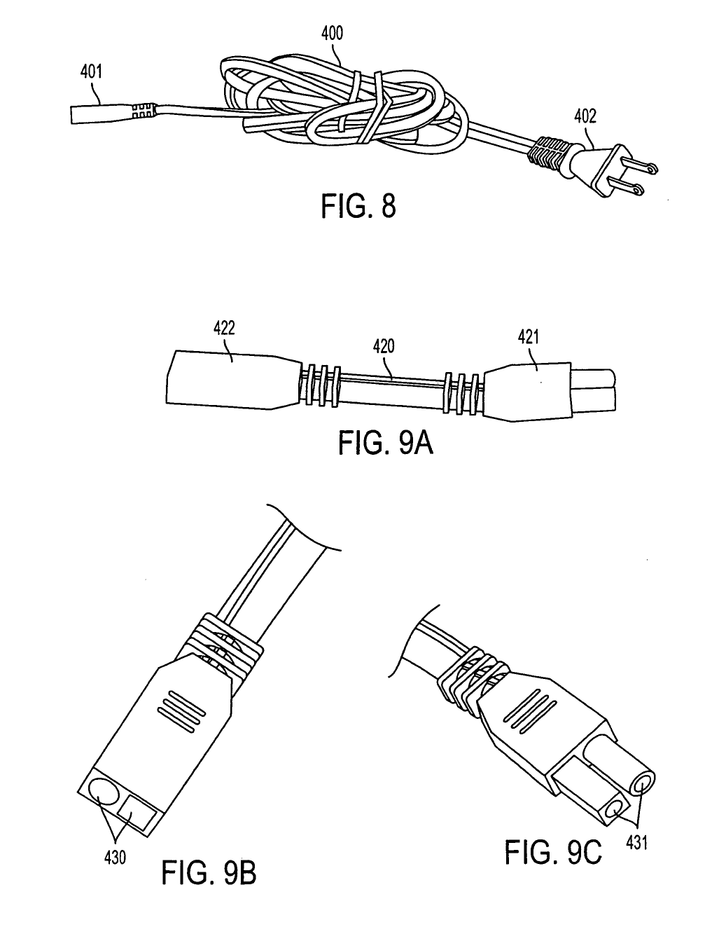

The present invention is a cabinet light system comprising integral male and female connectors to allow the interconnection of multiple units directly or with interconnection cord. The cabinet light shown in FIGS. 1 through 9 is a fluorescent strip type, which is provided with integral male and female connectors to allow the interconnection of multiple units directly or with interconnection cord. The cabinet light can be used, for example, with T5 bi-pin 9 Watt lamps. The maximum number of units interconnected together is limited by maximum current and power concerns. The unit may be provided with or without the lead power supply cord and/or interconnection cords shown in FIGS. 8 and 9.

FIG. 1 illustrates a frontal plan view of a florescent cabinet light 10. In an exemplary configuration, the florescent cabinet light 10 is a 9 Watt Fluorescent Cabinet Light. Florescent cabinet light 10 comprises mounting hardware 1, on each side, and a diffuser 3. The florescent cabinet light 10 further comprises an enclosure channel 4, enclosure channel cover 6, ballast 100 (not shown, inside enclosure channel), lamp interconnecting connectors 1, and internal wiring 13 (not shown). The mounting hardware 13 consists of thermoplastic clips 5 and screws (not shown). Clips 5 are preferably formed to snap fit to enclosure channel 4. In an exemplary configuration, the diffuser 3 comprises clear thermoplastic and is formed to snap fit onto enclosure channel 4. In this embodiment, the diffuser 3 has dimensions of 2 cm inside diameter, 2.2 cm outside diameter, 2 cm high, and 29.5 cm long. The internal wiring 15 consists of lamp holder leads and interconnecting conductors, AVLV2, No. 18 AWG minimum, rated 90° C. minimum.

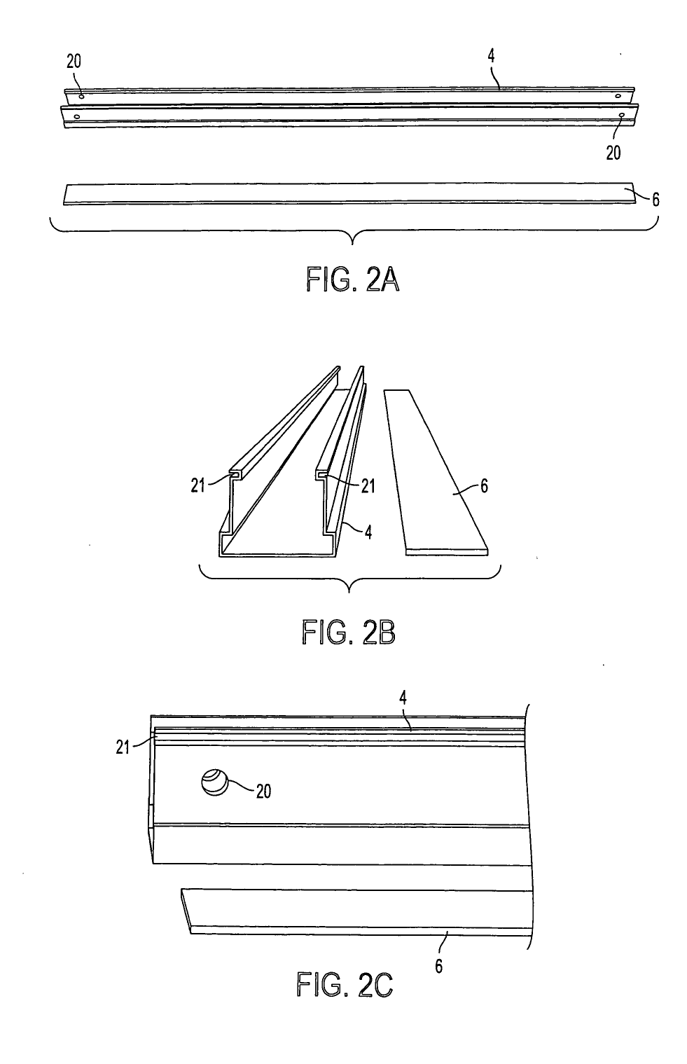

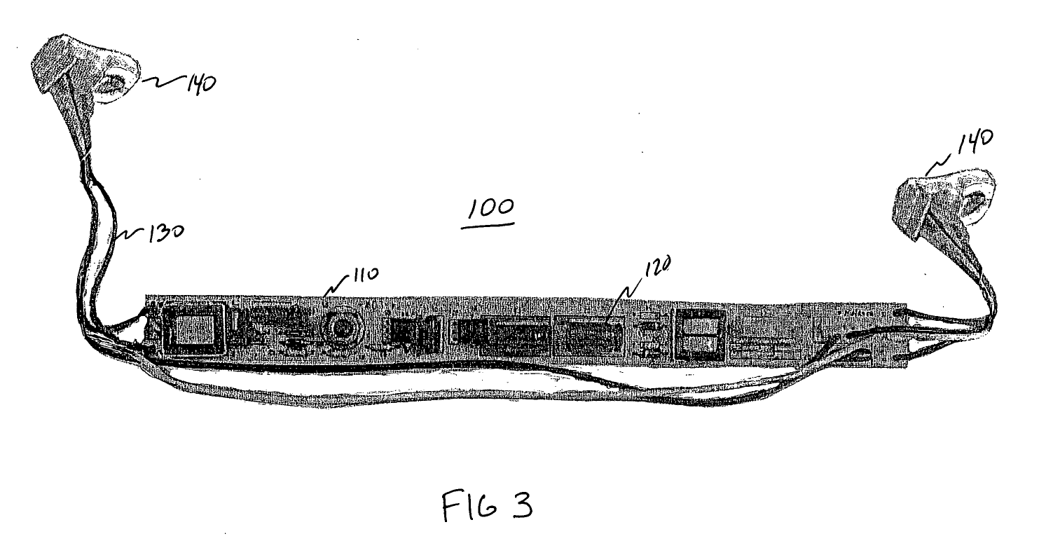

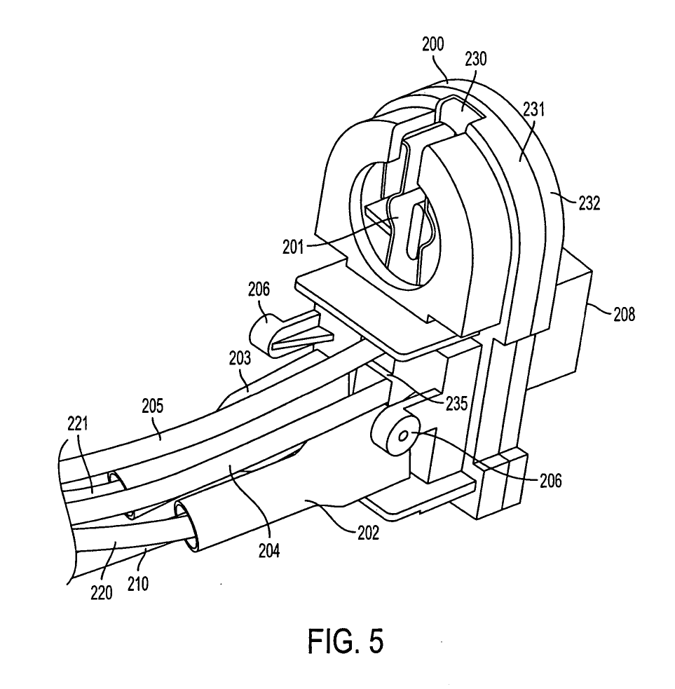

FIG. 2A illustrates a frontal view of the enclosure channel 4 and enclosure channel cover 6. FIG. 2B illustrates a side view of view of the enclosure channel 4 and enclosure channel cover 6 of FIG. 2A. FIG. 2C illustrates a close up view of one end of the enclosure channel 4 and enclosure channel cover 6 of FIG. 2A. In an exemplary embodiment, the enclosure channel 4 is molded of PVC, for example, QMFZ2 manufactured by LG Chemical Ltd., type 303. In this embodiment, the enclosure channel 4 is 1.6 mm thick minimum, 29.5 cm long; “U” shaped, and measures approximately 2 cm deep by 2 cm wide. In this embodiment, round openings 20 (4.5 mm diameter, center 9 mm from channel top opening and 10 mm from channel end) are punched on each side and at each end of the enclosure channel for mating with round tabs 206 (FIG. 5) on the lamp interconnecting connectors. The enclosure channel 4 is preferably provided with integral channel 21 for inserting the enclosure channel cover. In an exemplary embodiment, the enclosure channel cover 6 is molded of plastic, for example, QMFZ2 manufactured by LG. Chemical Ltd., type AF-303. In this embodiment, the enclosure channel cover 6 is 1.6 mm thick minimum, slides in integral channel of the enclosure channel and is secured with solvent type adhesive (the selection of such adhesive is well known in the art).

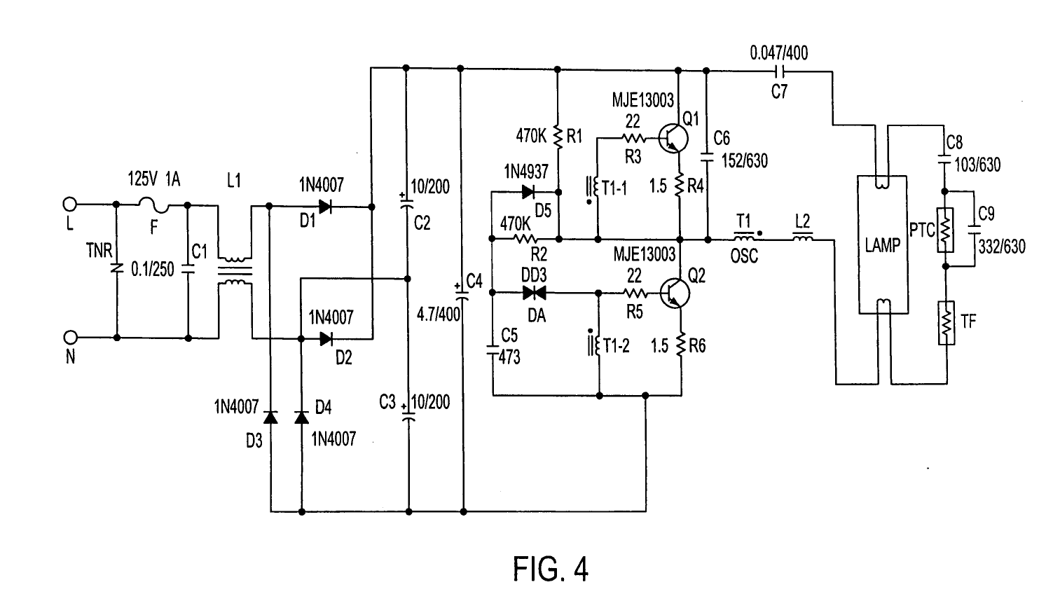

FIG. 3 is a frontal plan view of the ballast 100 assembled with a Printed Wiring Board 110 and various mounted components 120. The components, for example, can be configured in accordance with the schematic of FIG. 4 (discussed further below). Also shown is wiring 130 and lamp interconnecting connectors 140. The ballast is, in an exemplary embodiment, designed to be used for a T-5 9 Watt bi-pin straight tubular lamp, rated 120V/0.233 A.

FIG. 4 is the schematic for the ballast. Referring to FIGS. 3 and 4, in an exemplary embodiment, the ballast 100 comprises the following.

1. Printed Wiring Board 110—formed, for example, from ZPMV2 or QMTS2 laminate. In an exemplary embodiment, the approximate dimensions are 2 cm wide, 2 mm thickness, and 24 cm length. The wiring board 110, in this embodiment, is provided with minimum 105° C. QMJU2 conformal coating applied to the trace side of the printed wiring board.

2. Fuse F—Listed or JDYX2 rated minimum 125V, maximum 1 amp.

3. Varistor TNR—Listed or XUHT2, located on line side of fuse.

4. Across-the-Line Capacitor C1—Rated 0.1 uF, 120V minimum, 60° C. minimum. Located on load side of fuse.

5. Electrolytic Capacitors C2, C3—Rated 10 uF, 200V rated peak voltage, 65° C. minimum.

6. Inductor/input Choke L1—Isolation type with a ferrite core and a split phenolic bobbin. Line and neutral windings each consists of varnished copper magnet wire. Windings insulated from core with a single layer of Mylar tape. Rated 2 mH, 42 turns of No. 27 AWG, DC resistance of 0.48 Q+/−10%.

7. Torroid T1—Ferrite core with three varnished copper magnet wire windings rated 45 uH+/−10%, 7 turns of No. 26 AWG, DC resistance of 0.34 Q+/−10%.

8. Torroid TI-1, TI-2—Ferrite core with three varnished copper magnet wire windings rated 3.3 uH+/−10%, 2 turns of No. 26 AWG, DC resistance of 0.286 S2+/−10%.

9. Inductor/Output Choke L2—Phenolic bobbin with ferrite core with a single copper magnet wire winding. Winding insulated from core with a single layer of Mylar tape. Rated 3.3 mH+/−10%, 270 turns of No. 30 AWG, DC resistance of 3.552+/−10%.

10. Capacitor C5—Rated at 0.047 uF.

11. Capacitor C6—Rated at 0.015 uF, 1 kV peak voltage 12. Resistors R1, R2—Rated at 470 kQ+/−5%.

13. Resistors R3, R5—Rated at 22 Q+/−5%. 14. Resistors R4, R6—Rated at 1.5 Q+/−5%.

15. Output Capacitor (C7)—Rated at 0.047 uF, 400V peak voltage. 16. Output Capacitor (C8)—Rated at 0.01 uF, 630V peak voltage. 17. Starting Capacitor (C9)—Rated at 3300 pF, 630V peak voltage.

18. Output PTC—Specified 60R020.

19. Starting PTC TF—Specified PTC250.

20. Rectifier Diodes D1, D3—Rated at maximum 1 kV, 1 A maximum, specified 1 N4007.

21. Fast Switching Diode D5—Rated at maximum 600V, 1A maximum, specified 1 N4937.

22. DA—Specified D83.

23. Bipolar NPN Power Transistors Q1, Q2—Rated at 400V Vceo, 2A maximum, specified MJE 13003.

24. Input/Output/Interconnecting Leads—Attaches to quick connects and interconnecting contacts for connecting to lamp holder/interconnecting connector. AVLV2, minimum No. 18 AWG, rated 300V minimum, 105° C. minimum. Placement of leads explained in FIGS. 5-7.

The components listed above comprise an exemplary embodiment, alternative ballast arrangements may be used within the scope of the invention.

FIG. 5 illustrates a frontal plan view of an embodiment of the lamp interconnecting connector 140. In this embodiment, the lamp interconnecting connector 140 is configured for “power-in.” In this embodiment, the lamp interconnecting connector 140 comprises female contacts 208 and leads 210. In an exemplary embodiment, leads 210 attach to printed wiring board 110 in FIG. 3. Blue leads 220, 221, in an exemplary embodiment, are approximately 8.5 cm long are soldered to the wiring board in through holes marked by reference designators, which may be marked, for example, by reference designator “BL” (not shown). The ends of blue leads 202, 203 are crimped to female insulated quick disconnect terminals for attaching to prongs on the lamp holder/interconnecting connectors. In this embodiment, a female black lead 204 is approximately 13 cm long and is soldered to double circled through hole, marked, for example, by reference designator “BK” (not shown) on the wiring board 110. The other end is crimped with a female contact 230 (not shown) to stake into square opening 301 on the lamp interconnecting connector with female contacts 300.

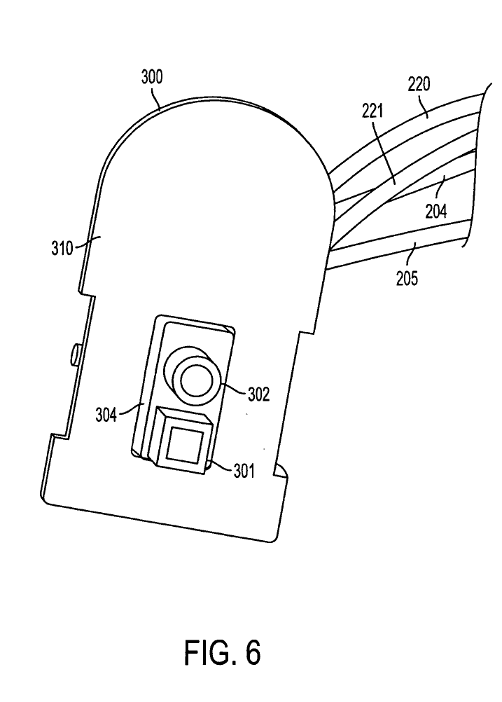

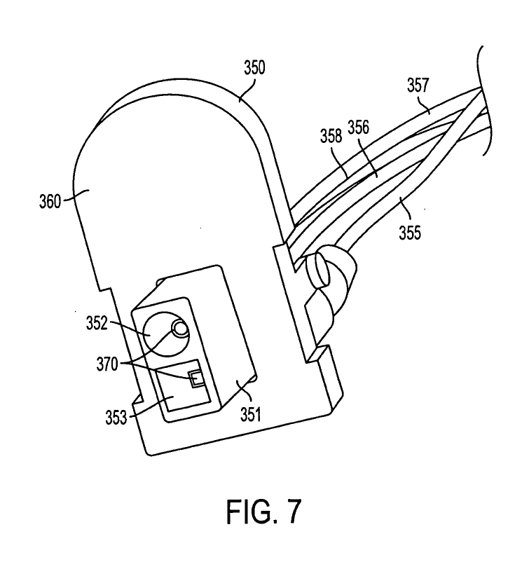

Referring also to FIGS. 6 and 7, a male black lead 356 is approximately 32 cm long is soldered to the smaller through hole 116 next to the double circled through hole marked, for example, by reference designator “BK” (not shown) on the wiring board 110. The other end is crimped by a male contact to stake into corresponding square opening 353 on the lamp interconnecting connector with male contacts 350. In this embodiment, a female white lead 203 is approximately 13 cm long is soldered to a double circled through hole, marked, for example, by reference designator “WH” (not shown) on the wiring board 110. The other end of female white lead 203 is crimped with a female contact to stake into square opening 301 on the lamp interconnecting connector with female contacts 300. A male white lead is approximately 32 cm long and is soldered to the smaller through hole next to the double circled through hole marked, for example, by reference designator “WH” on the wiring board 110. The other end of male white lead is crimped by a male contact to stake into corresponding square opening 353 on the lamp interconnecting connector with male contacts 350.

FIG. 6 illustrates a side view of the lamp interconnecting connector with female contacts 300. In an exemplary embodiment, the lamp interconnecting connector 300 comprises a lamp holder body 310, interconnecting contacts 311, and lamp holder contacts 201. In an exemplary embodiment lamp holder body 310, shaped as shown in FIGS. 1 and 2, is molded around interconnecting conductors 208 Lamp holder body 310 may be molded using QMFZ2 laminate manufactured by LG Chemical Co. Ltd., type AF-303. In a particular embodiment, lamp holder body 310 have 1.6 mm thickness minimum. The back 231 of body 310 is provided with a cover 232 which may attach by snap fits 230 which may be ultrasonically welded to front. Body 310 also provided with tabs 206 for securing to enclosure channel 4. In a particular embodiment, interconnector portion 231 of body 310 is keyed to only permit input supply cord connection.

In an exemplary embodiment, interconnecting contacts 304 are formed using copper or copper alloy. In a particular embodiment, male contacts crimped to minimum No. 18 AWG 600V, 105° C. AVLV2 and then contacts staked through lamp holder body 310. In this embodiment, male contacts are formed using copper or copper alloy. The male prong contacts are keyed for female quick disconnect terminals 202, 203 molded into lamp holder body.

In an exemplary embodiment, lamp holder contacts 201 are formed using a copper or copper alloy, spring type metal. In this embodiment, lamp holder contacts 201 are secured in channels 235 of lamp holder body 310 and provided with quick connects 202, 203 for connection of lamp pins. The channel and molding of lamp holder body aid in separation of contacts.

FIG. 7 illustrates a side view of the lamp interconnecting connector with male contacts 350. Lamp interconnecting connector with male contacts 350 is used for “power-out.” The lamp interconnecting connector with male contacts 350 comprises a lamp holder body 360, interconnecting contacts 351, and lamp holder contact 352. In an exemplary embodiment, lamp holder body 360 is formed identical to lamp holder body 310 in FIGS. 5 and 6, except for shape and interconnector portion 351 of body 360 is keyed to only permit output load cord connection. In other words the interconnector portion 351 is formed with a male connection. Interconnecting contacts 352, 353 are identical to FIGS. 5 and 6, except provided with male contacts. The lamp holder contacts (not shown) are identical to FIGS. 5 and 6.

FIG. 8 illustrates a view of a detachable power supply cord 400. Cord 400, as shown, attaches to lamp interconnecting connector 300 for “power-in”. Cord 400, comprises a cord 403, female connector 401 with contacts (not shown). In an exemplary embodiment, cord 400 is Listed, No. 2/18 AWG type NI SPT-2 flexible cord, rated 90° C. minimum, 3.05 m long minimum. Cord 400 is preferably provided with polarized NEMA parallel blade male plug on one end and two conductor female connectors 401 on the other end. The female connector 401 has a body keyed to prevent reverse polarity. In a particular embodiment one lead is keyed in a square shape and the other in a circular shape. In a particular embodiment, female connector 401 is formed using QMFZ2, Molded PVC type BLI001 manufactured by BL Korea Co. Ltd. In a particular embodiment, female connector 401 dimensions are 40.0 mm long (including strain relief), 13.0 mm wide (at body) by 7.0 mm high (at body), and contact shrouds 405 are provided, 1.0 mm thick minimum. Contacts 404 are used only in the female connector 401 and not in a male connector. In a particular embodiment, contacts 404 are recessed 3.0 mm from the top of shroud 405. In a particular embodiment, the contacts 404 dimensions are 17.0 mm long (including electrical connection and jacket crimp tabs), 0.3 mm thick, and 1.8 mm diameter. Contacts 404 also include a contact electrical connection 410. Contact electrical connection 410 comprises integral tabs, electrical connection tabs, 2.3 mm long, crimped to conductor, crimp length 1.5 mm. Contact electrical connection 410 further comprises jacket crimp tabs, which are preferably, 1.6 mm long, crimp length 0.9 mm.

FIG. 9 is a view of interconnection cord 420. Cord 420 is used to connect two lamp units together. In a particular embodiment, cord 420 is listed as Special Use Detachable Power Supply Cord, No. 18 AWG minimum, Type SPT-2, rated 90° C. minimum, length may vary. Cord 420 is provided with a two-conductor male plug 422 on one end and a two conductor female plug 421 on the other end. Plug bodies 421, 422 are keyed to prevent reverse polarity. In a particular embodiment, one lead is keyed in a square shape and the other in a circular shape.

In a particular embodiment, female connector 422 is formed using QMFZ2, Molded PVC type BLI001 manufactured by BL Korea Co. Ltd. In a particular embodiment, female connector 422 dimensions are 40.0 mm long (including strain relief), 13.0 mm wide (at body) by 7.0 mm high (at body), and contact shrouds 423 are provided, 1.0 mm thick minimum. Contacts 430 are used only in the female connector 401 and not in a male connector. In a particular embodiment, contacts 430 are recessed 3.0 mm from the top of shroud 432. In a particular embodiment, contacts 430 dimensions are 17.0 mm long (including electrical connection and jacket crimp tabs), 0.3 mm thick, and 1.8 mm diameter. Contacts 430 also include a contact electrical connection 433. Contact electrical connection 433 comprises integral tabs, electrical connection tabs, 2.3 mm long, crimped to conductor, crimp length 1.5 mm. Contact electrical connection 433 further comprises jacket crimp tabs, which are preferably, 1.6 mm long, crimp length 0.9 mm.

In a particular embodiment, male connector 421 is formed using QMFZ2, Molded PVC type BLI001 manufactured by BL Korea Co. Ltd. In a particular embodiment, female connector 421 dimensions are 40.0 mm long (including strain relief), 13.0 mm wide (at body) by 7.0 mm high (at body), and contact shrouds 423 are provided, 1.0 mm thick minimum. Pins 370 are used only in male connector. Pins 370 are recessed 3.0 mm from top of shroud 352, 353. In a particular embodiment, pins 370 are 17.8 mm long (including electrical connection and jacket crimp tabs) and 1.2 mm diameter (at top of pin). Pins 370 include pin electrical connection 375. Pin electrical connection 375 includes integral tabs 376, electrical connection tabs 377, 2.3 mm long, crimped to conductor with a crimp length of 1.5 mm. Pin electrical connection 375 is also provided with jacket crimp tabs, 1.6 mm long, crimp length 0.9 mm.

It will be understood, however, that although symmetry of the electrodes may be advantageous in some circumstances, it is not required in order to take advantage of the high frequency multi-phase input provided by the lamp drivers of the present invention.

It will be appreciated by those of ordinary skill in the art that the invention can be embodied in various specific forms without departing from its essential characteristics. The disclosed embodiments are considered in all respects to be illustrative and not restrictive. The scope of the invention is indicated by the appended claims, rather than the foregoing description, and all changes that come within the meaning and range of equivalents thereof are intended to be embraced thereby.

It should be emphasized that the terms “comprises”, “comprising”, “includes”, and “including”, when used in this description and claims, are taken to specify the presence of stated features, steps, or components, but the use of these terms does not preclude the presence or addition of one or more other features, steps, components, or groups thereof.

1. A cabinet light system comprising
a lamp connection system comprising a florescent strip lamp;
a male interconnector;
a female interconnector;
an enclosure channel;
a ballast;
wherein said male and female interconnectors are connected to opposite ends of said enclosure channel and are electrically connected to said ballast whereby power is provided to said ballast.

2. The system of claim 1, further comprising an enclosure cover wherein said enclosure channel includes an integral channel formed on said enclosure channel and said enclosure cover slidably attaches to said enclosure channel via said integral channel.

3. The system of claim 1, wherein said enclosure channel is U shaped.

4. The system of claim 1, wherein said enclosure contains a pair of tabs shaped to snap fit into at least one of said pair of openings.

5. The system of claim 1, wherein said female connector further comprises a body, interconnecting contacts, and holder contacts, and said body is molded around said interconnecting contacts.

6. The system of claim 1, wherein said male connector further comprises a body, interconnecting contacts and holder contacts, and said body is molded around said interconnecting contacts.

7. The system of claim 1, wherein said female connector includes an interconnector portion including said interconnector contacts wherein said interconnector portion is keyed to permit connection to only an input supply cord.

8. The system of claim 1, wherein said mail connector includes an interconnector portion is keyed to permit connection to only an output load cord.

9. The system of claim 1, further comprising a plurality of lamp interconnection systems is physically connected at a male end to a female end of at least one other lamp interconnection system.

10. The system of claim 1, further comprising a power supply cord having a male plug end and a two conductor female end, said two conductor female end being an input supply cord connection.

11. The system of claim 2, wherein said female connector is keyed with a first prong substantially square shaped and a second prong substantially circular shaped.

12. The system of claim 8, wherein said male connector is keyed with a first prong substantially square shaped and a second prong substantially circular shaped.

13. The system of claim 9, further comprising an interconnect cord, said interconnect cord including a male plug at a first end and a female plug at a second end and wherein said female plug is an input supply cord connection and said male plug is an output load cord connection.

14. The system of claim 13, wherein said female plug comprises contacts, integral tabs, electrical connection, a jacket crimp tabs and wherein said male plug comprises pins, electrical connection, and jacket crimp tabs.
